(19) United States
(12) Patent Application Publication
(10) Pub. No.: US 2010/0177013 A1
(43) Pub. Date: Jul. 15, 2010

(54) MIXED ANTENNA

(75) Inventors: Thibaut Wirth, Moirans (FR); Sylvain Perrot, Voirons (FR); Cyril Decroze, Pierre Buffiere (FR)

Correspondence Address: LOWE HAUPTMAN HAM & BERNER, LLP, 1700 DIAGONAL ROAD, SUITE 300, ALEXANDRIA, VA, 22314, US

(73) Assignee: TRIXELL, Moirans (FR)

(21) Appl. No.: 12/531,991

(22) PCT Filed: Mar. 11, 2008
(86) PCT No.: PCT/EP2008/052865

§ 371 Date: Feb. 25, 2010

(30) Foreign Application Priority Data
Mar. 20, 2007 (FR) 07 53933

(51) Int. Cl. H01Q 21/00; H01Q 9/04

(52) U.S. Cl. 343/893; 343/700 MS

(57) ABSTRACT

The present invention relates to a mixed antenna. The antenna comprises a wire-plate antenna and a PIFA antenna, a first antenna being connectable to an electric generator and the second antenna being coupled to the first by capacitive coupling.

### CROSS-REFERENCE TO RELATED APPLICATIONS

The present Application is based on International Application No. PCT/EP2008/052865, filed on Mar. 11, 2008, which in turn corresponds to French Application NO. 0753933 filed on Mar. 20, 2007, and priority is hereby claimed under 35 USC §119 based on these applications. Each of these applications are hereby incorporated by reference in their entirety into the present application.

### FIELD OF THE INVENTION

The present invention relates to a mixed antenna comprising a wire-plate antenna and a PIFA antenna. One of the antennas is connectable to an electric generator, the other antenna being coupled to the first by capacitive coupling. The invention applies notably in the field of telecommunications, to WiFi antennas for example.

### BACKGROUND OF THE INVENTION

A digital radiological cassette makes it possible to store one or more digital images of a patient illuminated in transparency by X-rays, without necessarily having to place the patient in a strictly delimited mechanical environment, the cassette being portable and therefore easy to manipulate. If moreover this cassette is wireless, mobility and ease of use are increased. But dispensing with the wire makes it necessary to transmit the digital image to the hospital's information system by way of a transmit radio antenna. This poses practical difficulties.

On the one hand, a certain mechanical robustness of the cassette is necessary to ensure reliability in the event of a fall or knocks, as well as for protection against outside electromagnetic disturbances. This requires that the device be enclosed in a metal shell forming a Faraday cage and ensuring shielding. Whether the antenna is placed inside, this being the worst electromagnetic case, or outside, this being the worst case in respect of mechanical protection, the influence of this metal mass prevents the use of on-PCB flat antennas. The radio constraints being considered to be greater relative to the mechanical constraints, the antenna must necessarily be placed outside the metal shell. However, the space available outside is very small and defines an area rather than a volume. The antenna must also be protected from knocks and liquids frequently used in a hospital setting in order to clean the instruments.

Moreover, the medical environment requires compliance with strict medical standards from the point of view of transmitted radio power. The standard IEC 60601-1-2 limits the instantaneous power of radiation transmitted (IPRT) to a maximum of 1 milliwatt. This power restriction makes it difficult to use an off-the-shelf antenna such as an antenna of “WiFi” type, whose nominal power is generally of the order of 100 mW. They can easily be limited to 1 milliwatt, but then the metallic environment constituted by the cassette causes a critical misfit of the antenna to this power level. Off-the-shelf “WiFi” antennas are therefore definitively not fit for use in a digital radiological cassette. But making a “WiFi” antenna that is dedicated to use in a digital radiological cassette still poses numerous technical difficulties.

Indeed, such an antenna is firstly required to cover a broad frequency band or indeed several bands because of the regulatory disparities between countries. So numerous standards known commercially as “WiFi” have appeared on the scene: these standards are for example IEEE 802.11a, IEEE 802.11b, IEEE 802.11g or IEEE 802.11n. The IEEE 802.11b and IEEE 802.11g standards provide several communication channels between 2.4 and 2.5 gigahertz. The IEEE 802.11a standard provides several channels between 5 and 6 gigahertz. Thus, an almost multi-purpose WiFi link, compatible at least with the three standards IEEE 802.11a, IEEE 802.11b and IEEE 802.11g, requires the use of a multi-band antenna capable of sending and receiving information on several frequency bands. Numerous constraints arise in respect of such an antenna. First of all there are the conventional antenna constraints relating to direction of operation and power. But, above all, there are also size constraints. Indeed, the use of a WiFi link is justified essentially on a portable device offering reduced weight and size. Such is typically the case for a digital radiological cassette.

The antenna must be omnidirectional, or at the very least it must have a radiation pattern that is as uniform as possible in space. So the user does not have to worry about the relative position or the orientation of the cassette with respect to the receiving WiFi set.

The antenna must have a certain range in transmission, the range often depending on the context of use. For example, the off-the-shelf WiFi cards to be installed in portable or office computers have variable ranges, the user being able to choose his card (and the budget that he wishes to allot to it) as a function of the conditions of use such as the area to be covered, the number of stories or the thickness of the walls. Now, the range of an antenna is directly proportional to its transmission power, which is known to be subject to a regulatory limitation to 1 milliwatt in a hospital setting. Under such conditions, satisfying at one and the same time the range requirements and at one and the same time the limitation in regard to power transmitted by the antenna turns out to be complicated. Even if the problem involved is essentially that of a medical standard, neither should it be overlooked that the antenna must form an integral part of a portable device supplied from a rechargeable battery system which is therefore of limited power. The antenna must therefore have excellent efficiency, that is to say restore in the form of radiation a maximum amount of the energy provided to it by the battery.

The antenna must be multi-band, at least matched to various frequencies of the WiFi standards. Now, generally an antenna is matched to a given frequency. At this given frequency, if the antenna is supplied with energy through a cable, it must radiate a maximum amount of this energy and return a minimum amount thereof to the cable. Thus, if the power supply system has for example an impedance of 50 ohms, the antenna must also have an impedance of 50 ohms. This is easy to achieve for an antenna having to work in a single frequency band, especially a narrow band. But it is much more difficult to achieve when the antenna must work in several bands, possibly wide bands such as that of the IEEE 802.11a standard permitting heavy data throughputs.

The antenna must also have a reduced size so as to be integrated into a portable device.

Specifically, if any one of these points is not dealt with and resolved satisfactorily, it is very difficult to obtain a satisfactory link budget. The ratio between the power received by the receiving antenna and the power transmitted by the transmitting antenna is very low, resulting in a significant error rate on the line.

Similar technical problems are encountered notably in the field of portable computers comprising a WiFi antenna. The problems posed by the rechargeable power supply are amplified by the fact that a portable computer can be used away from the mains for relatively long durations. Such is not the case for a digital radiological cassette. The antennas used on portable computers are dipoles printed on a dielectric substrate, also called “2D antennas”, the antenna being encased in a plastic package insulating them from any contact with metallic elements. These antennas are particularly suitable for being integrated into varied systems. But a digital radiological cassette takes the form externally of a metallic shielding shell. If the 2D antenna is placed inside, it does not radiate outside. If it is placed outside, the metal shell considerably disturbs its radiation, rendering it ineffective.

An alternative solution which could be envisaged is the use of an antenna mounted on a ground plane, also called “3D antennas”. More voluminous, such antennas are generally used to illuminate big volumes, an entire building for example. These are for example antennas known as “PIFA” antennas (Planar Inverted F Antenna). But to obtain multi-band operation with a PIFA antenna, the latter's dimensions must be sufficient for its radiating plane to be able to comprise slots. These dimensions are incompatible with the width, length and thickness available outside a digital radiological cassette. In the volume allocated to the antenna, only a mono-band PIFA antenna could fit. Another alternative solution which could be envisaged is the use of a 3D antenna according to patent EP 0 667 984 B1. Indeed, an antenna of wire-plate type with several radiating planes according to this patent can cover several frequency bands. But it is much too big in size, notably as regards thickness, to be able to be assembled to the outside of a digital radiological cassette.

### SUMMARY OF THE INVENTION

A technical problem to which the present invention proposes to respond is to provide an antenna having similar characteristics in terms of radiation to the known 3D antennas, but offering a much smaller size.

The aim of the invention is notably to provide a multi-band antenna offering a very small size. For this purpose, the subject of the invention is a mixed antenna comprising a wire-plate antenna and a PIFA antenna. One of the antennas is connectable to an electric generator. The other antenna is coupled to the first by capacitive coupling.

Advantageously, the antenna can be multi-band in frequency.

In one embodiment, the wire-plate antenna and the PIFA antenna can each comprise a radiating plate, the two plates each being able to be disposed on a radiating element and the two elements each being able to be disposed on a ground plane. The two radiating plates can be in one and the same plane and separated by a slot of constant width, the slot ensuring the capacitive coupling of the two plates.

Advantageously, the two radiating elements can be disposed on one and the same ground plane.

The slot between the two plates can form a pattern, the pattern increasing the length of the slot and its capacitance. For example, the pattern formed by the slot between the two plates can form a rectangular protrusion of one of the plates into the other plate.

In one embodiment, a central strand of a coaxial cable can be connected to one of the radiating plates and the peripheral braid of the coaxial cable can be connected to the ground plane. The central strand can link the plate to the electric generator and the peripheral braid can link the ground plane to the electrical ground. For example, the central strand of the coaxial cable can link the radiating plate of the PIFA antenna to the electric generator.

The antenna can be encased in a plastic chassis, the chassis possibly being fixed to the outside of a digital radiological cassette, the plastic chassis insulating the antenna from the disturbances caused by the metal casing of the cassette.

In addition to the fact of offering a very small size for similar performance to the known 3D antennas, the invention furthermore has the main advantages that it only requires the implementation of regular techniques for fabricating 3D antennas. Its final cost is entirely comparable with that of a PIFA antenna or of a conventional wire-plate antenna.

Still other objects and advantages of the present invention will become readily apparent to those skilled in the art from the following detailed description, wherein the preferred embodiments of the invention ae shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in naure, and not as restrictive.

### BRIEF DESCRIPTION OF THE INVENTION

The present invention is illustrated by way of example, and not by limitation, in the figures of the accompanying drawings, wherein elements having the same reference numeral designations represent like elements throughout and wherein:

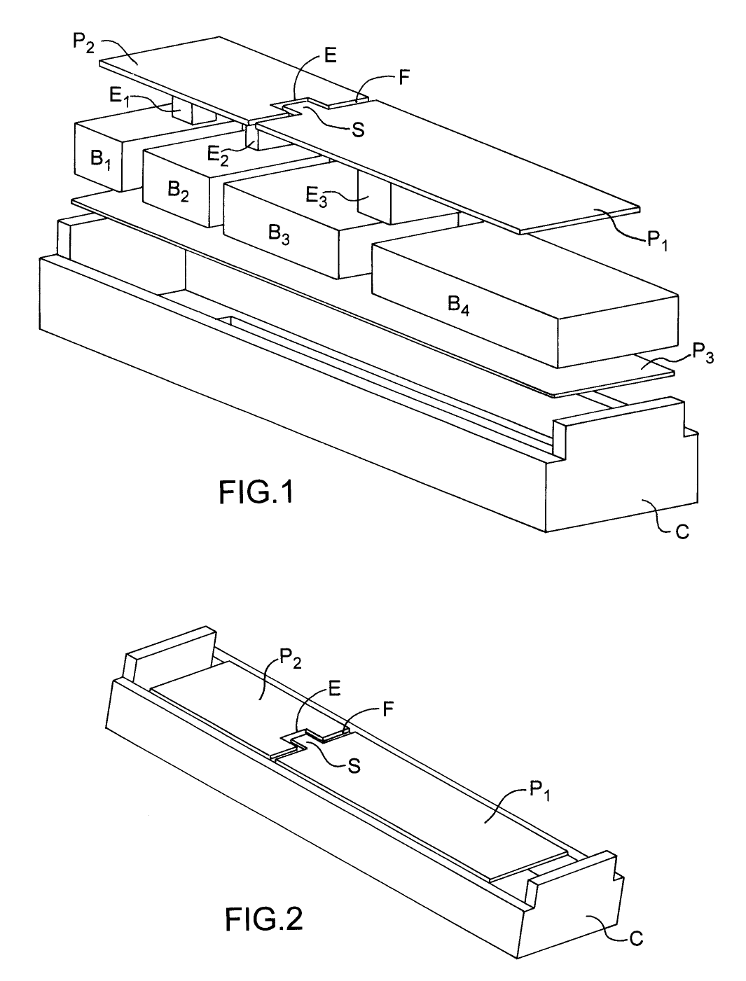

FIG. 1, through an exploded view, an exemplary mixed antenna according to the invention intended to be integrated on a digital radiological cassette;

FIG. 2, a perspective view of the same exemplary mixed antenna according to the invention;

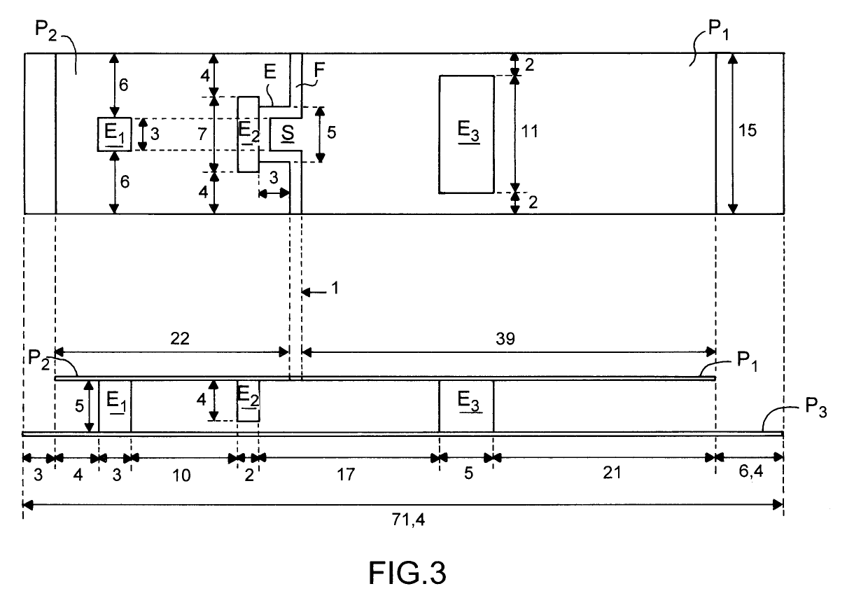

FIG. 3, through a design diagram, the dimensions of the same exemplary mixed antenna according to the invention;

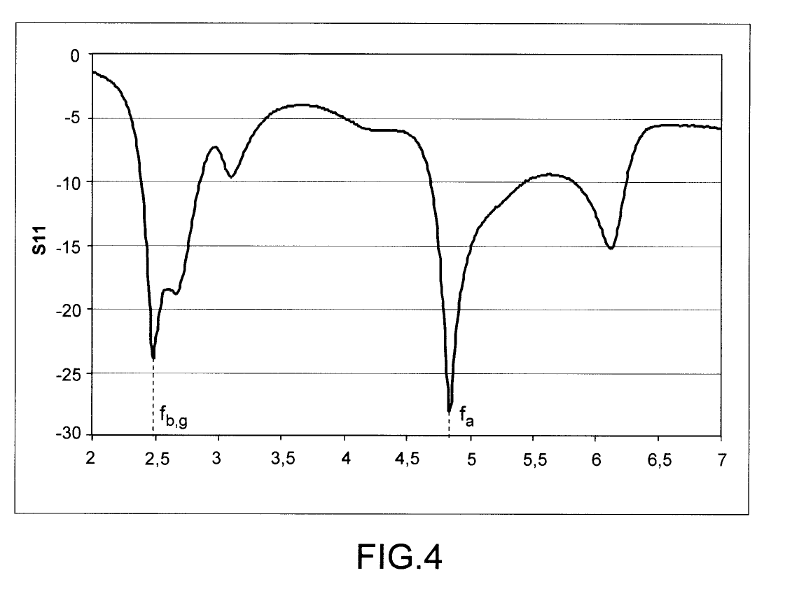

FIG. 4, through a graph, the radiation pattern of the same exemplary mixed antenna according to the invention.

### DETAILED DESCRIPTION

FIG. 1 illustrates through an exploded view an exemplary mixed antenna according to the invention, intended to be integrated on a digital radiological cassette. It comprises for example a radiating plate P₁ made of conducting material of rectangular shape and comprising for example a protrusion S forming a square pattern on one of its small sides. The plate P₁ is mounted for example on a radiating element E₃ made of conducting material and tile-shaped, the element E₃ supporting the plate P₁ by way of a conducting link. The element E₃ is disposed for example on a metal ground plane P₃, in direct contact. The plate P₁, the element E₃ and the metal ground plane P₃ form a wire-plate antenna.

The mixed antenna according to the invention comprises for example a radiating plate P₂ made of conducting material of rectangular shape and comprising for example a notch E forming a rectangle pattern on one of its small sides. The large sides of the rectangle forming the notch E are slightly larger than the sides of the square forming the protrusion S. The plate P₂ is mounted for example on a radiating element E₁ made of conducting material and cube-shaped, the element E₁ supporting the plate P₂ by way of a conducting link. The element E₁ is for example disposed on the metal ground plane P₃, in direct contact. But a distinct ground plane could have been envisaged. A radiating element E₂ made of conducting material and tile-shaped is fixed under the plate P₂: it is not in contact with the ground plane P₃. The plate P₂, the elements E₁ and E₂, as well as the metal ground plane P₃ form a PIFA antenna. Not represented in FIG. 1 for reasons of clarity, a coaxial cable of suitable cross section can for example supply the PIFA antenna with electric current by way of the element E₂. A hole is then drilled in the ground plane P₃ opposite the element E₂, the diameter of the hole being substantially equal to the cross section of the cable. The central strand of the cable passes through the hole without establishing contact with the ground plane P₃. It is soldered by its end to the element E₂. The braided sheath of the coaxial cable can for its part be advantageously soldered at the level of the edges of the hole made in the ground plane P₃. The central strand then provides electric current, the braided sheath being linked to the electrical ground.

The mixed antenna according to the invention achieves a coupling of the wire-plate antenna and of the PIFA antenna. Advantageously, the dimensions of the elements E₁ and E₃ are such that the plates P₁ and P₂ are in one and the same plane, the element E₁ and the element E₃ being arranged in such a way that the plates P₁ and P₂ are for example separated by a slot F. Advantageously, the protrusion S fits contactlessly into the notch E, the slot F being of small and constant width. In this way, as soon as the PIFA antenna is supplied with electric current through the central strand of the coaxial cable, induced currents appear in the wire-plate antenna. The wire-plate antenna is coupled to the PIFA antenna by capacitive coupling. It should be noted that, generally, a PIFA antenna or a wire-plate antenna are not characterized by their mode of power supply. They can equally well be powered by electrical contact or by capacitive coupling. What characterizes them is rather their mode of resonance. Indeed, the mode of resonance of a wire-plate antenna is of electrical type, the currents being concentrated rather more on the ground wire, that is to say on the radiating element E₃ supported by the ground plane P₃ in the present exemplary embodiment. The radiation of a wire-plate antenna is omnidirectional in azimuth. The antenna behaves as a monopole radiating with single vertical polarization, the polarization of the radiated field being perpendicular to the so-called “short-circuit” wire of the antenna, that is to say perpendicular to the radiating element E₃ in the present exemplary embodiment. Whereas the mode of resonance of a PIFA antenna is of electromagnetic type, the currents dispersing over the whole of the structure of the antenna. The antenna behaves as a dipole radiating as a total field uniform throughout space. This uniformity is due to the sum of the two polarizations radiated by this antenna, a horizontal polarization arising from the currents circulating on the plate P₂ and a vertical polarization arising from the so-called “short-circuit” plate of the antenna, that is to say arising from the radiating element E₁ in the present exemplary embodiment. It should also be noted that the slot F between the two antennas does not have a resonance role, but that it advantageously ensures the coupling function. Advantageously, the pattern that it forms makes it possible to increase its capacitance with respect to a straight slot without a pattern. The slot F of the mixed antenna according to the invention therefore cannot be likened to the resonant slot of a conventional PIFA antenna.

The two types of antenna therefore differ through their very operating principle. It should be noted moreover that the position of the elements E₁ and E₃ in relation to their respective radiating plate P₂ and P₁ plays a determining role in the mode of resonance of the antenna formed. To make a PIFA antenna, the element E₁ must rather be off-centered with respect to the radiating plate P₂. To make a wire-plate antenna, the element E₃ must rather be centered with respect to the radiating plate P₁. Incidentally, this relative position determines the function of the element in the antenna formed, the function of the element E₁ of the PIFA antenna not being at all comparable with the role of the element E₃ of the wire-plate antenna.

Including the slot F, the aggregate surface area of the thus adjoining plates P₁ and P₂ is substantially identical in width to the surface area of the ground plane P₃ on which they rest and slightly shorter in length. Blocks B₁, B₂, B₃ and B₄ of a dielectric material are sandwiched between the plates P₁ and P₂, blocks B₁ and B₂ being on either side of the element E₁, blocks B₂ and B₃ being on either side of the element E₂, and blocks B₃ and B₄ being on either side of the element E₃. The blocks B₁, B₂, B₃ and B₄ do not protrude from the sandwich formed by the plates P₁ and P₂ and by the ground plane P₃.

The mixed antenna according to the invention for a digital radiological cassette is advantageously encased in a molded plastic chassis C. The plastic chassis C makes it possible on the one hand to fix the mixed antenna according to the invention to the exterior shielding of a digital radiological cassette, not represented in FIG. 1. The plastic chassis C also makes it possible to isolate the antenna from the significant metal mass constituted by the shielding shell, thus preventing the radiation of the antenna from being disturbed thereby. Its role is therefore determining in the application to a digital radiological cassette. It also ensures the leaktightness of the antenna and protects it against knocks.

FIG. 2 illustrates through a perspective view the exemplary mixed antenna according to the invention, already illustrated in FIG. 1, for a digital radiological cassette. The antenna is completely assembled. Only the radiating plates P₁ and P₂ are visible, flush with the plastic chassis C and separated by the slot F. The mixed antenna according to the invention is ready for assembly with a cassette by way of the chassis C.

FIG. 3 illustrates through a design diagram the dimensions of the mixed antenna according to the invention, already illustrated in FIGS. 1 and 2, for a digital radiological cassette. The same diagram depicts a top view, in the upper part of FIG. 3, and a profile view, in the lower part of FIG. 3. All the dimensions are expressed in millimeters. The diagram attests to the very small size of the mixed antenna according to the invention.

The top view depicts the radiating plates P₁ and P₂ whose protrusion S and notch E are separated by the slot F, together with the elements E₁, E₂ and E₃. The profile view depicts not only the radiating plates P₁ and P₂ and the elements E₁, E₂ and E₃, but also the ground plane P₃. The ground plane P₃ has a length of only 71.4 millimeters. The plates P₁ and P₂ and the ground plane P₃ have a width of only 15 millimeters. Disregarding the protrusion S and the notch E, the plates P₁ and P₂ have a length of 39 and 22 millimeters respectively. The protrusion S has the shape of a square 3 millimeters by 3 millimeters. The notch E extends over 5 millimeters in the width of the plate P₂, and penetrates 3 millimeters into the length of the plate P₂. Thus, the slot F between the plates P₁ and P₂ is only 1 millimeter wide. The plates P₁ and P₂ are spaced only 5 millimeters apart from the ground plane P₃, these 5 millimeters corresponding to the height of the elements E₁ and E₃ supporting the plates P₂ and P₁ respectively. The element E₂ being only 4 millimeters in height, it is spaced 1 millimeter away from the ground plane P₃. It should be noted that each of the elements E₁, E₂ and E₃ has a surface area in the horizontal plane which is negligible with respect to the plate that it supports (this being the case for E₁ and E₃), or with respect to the plate which supports it (this being the case for E₂). Indeed, the elements E₁ and E₂ have respective horizontal surface areas of 3×3=9 square millimeters and 7×2=14 square millimeters, this being negligible with respect to the surface area of the plate P₂ which is 15×22=330 square millimeters. The element E₃ has a horizontal surface area of 11×5=55 square millimeters, this being negligible with respect to the surface area of the plate P₁ which is 15×39=585 square millimeters. This is why from an electromagnetic point of view, the elements E₁, E₂ and E₃ behave similarly to conducting wires. But such elements have been preferred to conducting wires by reason notably of their mechanical robustness. The dimensions of the order of a few millimeters of the present exemplary mixed antenna according to the invention render the latter particularly suitable for portable applications, a digital radiological cassette for example.

Each of the elements E₁ and E₃ is positioned substantially in the middle of the width of the plate that it supports, E2 is positioned substantially in the middle of the width of the plate which supports it. The element E₁ is 6 millimeters from each of the two lateral edges of the plate P₂. The element E₂ is 4 millimeters from each of the two lateral edges of the plate P₂. The element E₃ is 2 millimeters from each of the two lateral edges of the plate P₁. On the other hand, because of structural constraints aimed at obtaining the characteristic radiation of a PIFA antenna, neither the element E₁ nor the element E₂ are positioned in proximity to the middle of the length of the plate P₂. For example, the element E₁ is positioned 4 millimeters from the opposite edge of the plate P₂ from the plate P₁, the element E₂ is positioned 3 millimeters from the other edge of the plate P₂, adjacent to the plate P₁, bordering the notch E. Likewise, because of structural constraints aimed at obtaining the characteristic radiation of a wire-plate antenna, the element E₃ is positioned relatively close to the middle of the length of the plate P₁. For example, the element E₃ is positioned 21 millimeters from the opposite edge of the plate P₁ from the plate P₂, the plate P₁ being 39 millimeters long overall.

FIG. 4 illustrates the radiation pattern of the exemplary mixed antenna according to the invention, already illustrated by FIGS. 1, 2 and 3, for a digital radiological cassette. The abscissa represents the frequency in gigahertz. The ordinate represents the reflection coefficient of the antenna in decibels, commonly called S11. An antenna is considered to be matched to a given frequency if, at this frequency, its reflection coefficient S11 is less than −6 decibels. It is apparent that the dimensions of the wire-plate antenna formed by the radiating plate P₁, the radiating element E₃ and the ground plane P₃ allow it to radiate effectively at a frequency f_{b,g} of the order of 2.4 to 2.5 gigahertz, the coefficient S11 exhibiting a minimum at almost −25 decibels at the frequency f_{b,g}. The antenna is therefore matched to the frequency f_{b,g}., which corresponds to the wave range of the WiFi 802.11b and 802.11g standards. The lower dimensions of the PIFA antenna formed by the radiating plate P₂, the element E₁ and the ground plane P₃ allow it to radiate effectively in a much higher frequency range fₐ of the order of 5 and 6 gigahertz, the coefficient S11 exhibiting a minimum at almost −30 decibels at the frequency fₐ. The antenna is therefore matched to the frequency fₐ, which corresponds to the wave range of the WiFi 802.11a standard.

The mixed antenna according to the invention illustrated by FIGS. 1, 2, 3 and 4 of the present patent application, where the PIFA antenna and the wire-plate antenna are coupled along their widths, is given only by way of example. Examples of mixed antennas according to the invention where the PIFA antenna and the wire-plate antenna would be coupled along their lengths are entirely conceivable without deviating from the principles stated by the present invention. Varying the dimensions and the relative positions of the PIFA antenna and of the wire-plate antenna makes it possible notably to tailor the mixed antenna according to the invention to given ranges of frequencies, that is to say to optimize its reflection coefficient S11 at the desired frequencies of use.

Multi-band and of reduced size, the mixed antenna according to the invention is particularly tailored to portable applications of the various WiFi standards, such as a digital radiological cassette for example.

It will be readily seen by one ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalents thereof.

1. A mixed antenna comprising a wire-plate antenna and a PIFA antenna, a first antenna being connectable to an electric generator and the second antenna being coupled to the first by capacitive coupling.

2. The mixed antenna as claimed in claim 1, wherein the antenna is multi-band in frequency.

3. The mixed antenna as claimed in claim 1, wherein the wire-plate antenna and the PIFA antenna each comprise a radiating plate, the two plates each being disposed on a radiating element, the two elements each being disposed on a ground plane, the two radiating plates being in one and the same plane and separated by a slot of constant width, the slot ensuring the capacitive coupling of the two plates.

4. The mixed antenna as claimed in claim 3, wherein the two radiating elements are disposed on one and the same ground plane.

5. The mixed antenna as claimed in claim 3, wherein the slot between the two plates forms a pattern, the pattern increasing the length of the slot and its capacitance.

6. The mixed antenna as claimed in claim 5, wherein the pattern formed by the slot between the two plates forms a rectangular protrusion of one of the plates into the other plate.

7. The mixed antenna as claimed in claim 3, wherein a central strand of a coaxial cable is connected to one of the radiating plates and the peripheral braid of the coaxial cable is connected to the ground plane, the central strand linking the plate to the electric generator and the peripheral braid linking the ground plane to the electrical ground.

8. The mixed antenna as claimed in claim 7, wherein the central strand of the coaxial cable links the radiating plate of the PIFA antenna to the electric generator.

9. The mixed antenna as claimed in claim 1, wherein it is encased in a plastic chassis, the chassis being fixed to the outside of a digital radiological cassette, the plastic chassis insulating the antenna from the disturbances caused by the metal casing of the cassette.
